(19) United States
(12) Patent Application Publication
(10) Pub. No.: US 2008/0297656 A1
(43) Pub. Date: Dec. 4, 2008

(54) Video Processing Device and Video Processing Method

(75) Inventor: Keiji Saito, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/128,560

(22) Filed: May 28, 2008

(30) Foreign Application Priority Data
May 31, 2007 (JP) 2007-145800

(51) Int. Cl. H04N 3/27; H04N 5/50

(52) U.S. Cl. 348/554; 348/569; 348/E05.097; 348/E03.049

(57) ABSTRACT

According to one embodiment, a video processing device comprises a communication unit which communicates with other video processing devices via communication paths, a remote controller communication unit which receives operation signals corresponding to operations of a predetermined key of a remote controller, and a control unit which performs processing by selecting either a first control mode that controls operations of the video processing device by the operation signals from the remote controller unit or a second control mode that controls operations of other video processing devices by the operation signals from the remote controller communication unit.

### CROSS-REFERENCE TO RELATED APPLICATIONS

This application is based upon and claims the benefit of priority from Japanese Patent Application No. 2007-145800, filed May 31, 2007, the entire contents of which are incorporated herein by reference.

### BACKGROUND

1. Field

One embodiment of the invention relates to a video processing device and a video processing method configured to also perform a menu operation for other video processing devices connected through the High-Definition Multimedia Interface (HDMI), etc., in response to one key operation of a remote controller.

2. Description of the Related Art

As generally known, in recent years, digital techniques have been widely used; communication standards among digital devices have included many different things. The HDMI, that is one of the communication standards of the digital devices, is a standard for making communication of a video audio signal and communication of control information at communication speeds which are different from each other through one cable, and its application examples also have been known.

Jpn. Pat. Appln. KOKAI Publication No. 2004-208290 discloses a technique, which detects a manufacturer code and a device code included in the data to be transmitted from a remote controller on a destination device side, determines that, for which source devices connected to the destination device through the HDMIs, the operation of the remote controller has been performed, based on the code information, makes HDMI connection to the source device to be object, and transmits an HDMI-Consumer Electronics Control (CEC) command to the source device.

However, in the technique disclosed in Jpn. Pat. Appln. KOKAI Publication No. 2004-208290, the remote controller is prepared for each connected device to be controlled; a user has to operate a plurality of theses remote controllers by exchanging the remote controller for another remote controller.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view illustrating an example of the invention, and a view illustrated for explaining a block configuration diagram of a video processing system;

FIG. 2 is a view for explaining an example of an HDMI that is a communication standard to be used by the video processing system regarding the embodiment;

FIG. 3 is an external appearance view illustrated for explaining an example of a remote controller of a video processing device to be composed of the video processing system regarding the embodiment;

FIGS. 4A-4D are each views to be illustrated for explaining examples of menu screens to be displayed by the video processing devices regarding the embodiment;

FIG. 5 is a view illustrated for explaining an example of a PLAY screen in the menu screen to be displayed by a video processing device regarding the embodiment;

FIG. 6 is a flowchart illustrated for explaining an example of display processing of the menu screen to be performed by a video processing device on a destination side regarding the embodiment;

FIG. 7 is a flowchart illustrated for explaining an example of display processing of the menu screen to be performed by a video processing device on a source side regarding the embodiment;

FIG. 8 is a block configuration diagram illustrated for explaining an example of a configuration of the video processing device on the destination side regarding the embodiment; and

FIG. 9 is a block configuration diagram illustrated for explaining an example of a configuration of the video processing device on the source side regarding the embodiment.

### DETAILED DESCRIPTION

Various embodiments according to the invention will be described hereinafter with reference to the accompanying drawings. In general, according to one embodiment of the invention, a video processing device comprises a communication unit which communicates with other video processing devices via communication paths, a remote controller communication unit which receives operation signals corresponding to operations of a predetermined key of a remote controller, and a control unit which performs processing by selecting either a first control mode that controls operations of the video processing device by the operation signals from the remote controller unit or a second control mode that controls operations of other video processing devices by the operation signals from the remote controller communication unit.

Hereinafter, an embodiment of the invention will be described in detail with reference to the drawings. At first, the outline of the embodiment regarding the invention will be described.

(Outline)

It is possible for the devices corresponding to the HDMI-CEC to give and take commands mutually through a CEC line and to mutually perform changes in displays of menu screens and set values of setting items and executions of commands. In such a case, making a user able to execute an operation of a remote controller for a destination device and an operation of a remote controller for a source device by the use of a single remote controller extremely improves the convenience of the user.

A video processing system is in a state in which the video from the source device is displayed on the destination device, when the user firstly presses a menu key 12 of the remote controller so as to display the menu screen, the video processing system displays the menu of the destination device, after this, the system interprets that the operations of the remote controller, such as Up/Down and Right/Left keys, a Confirm key and a Cancel key are made for the destination device until the menu screen is closed. When the menu key 12 is pressed again after the menu of the destination device is brought into a state in which the menu is closed, the system makes the source device display the menu screen by using a CEC command, and after this, the system interprets that the operation of the Up/Down and Right/Left keys, the Confirm key and the Cancel key are made for the source device until the menu screen is closed. That is, alternatively repeating the operations of the remote controller to the destination device and the operations of the remote controller to the source device on the basis of the display of the menu screen enables controlling the two devices that are the destination device and the source device by the use of the single remote controller. The remote controller itself may be the remote controller of the destination device and may be the remote controller of the source device. In contrast, the system may firstly start from the display of the menu screen on the source device side.

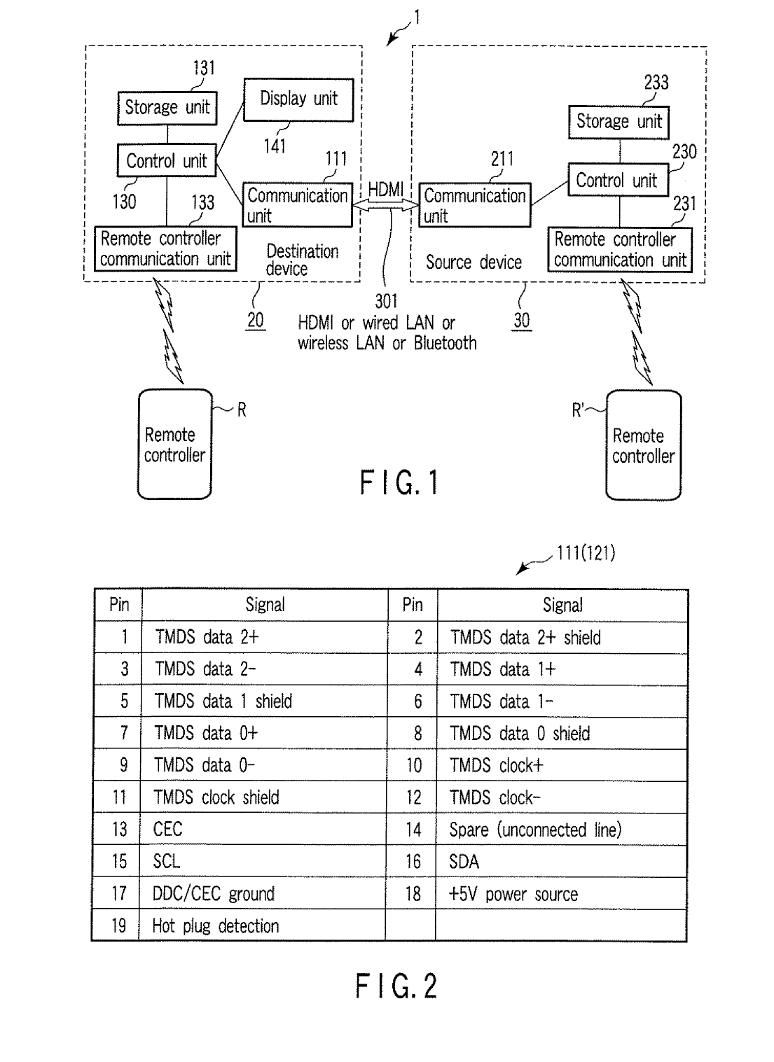

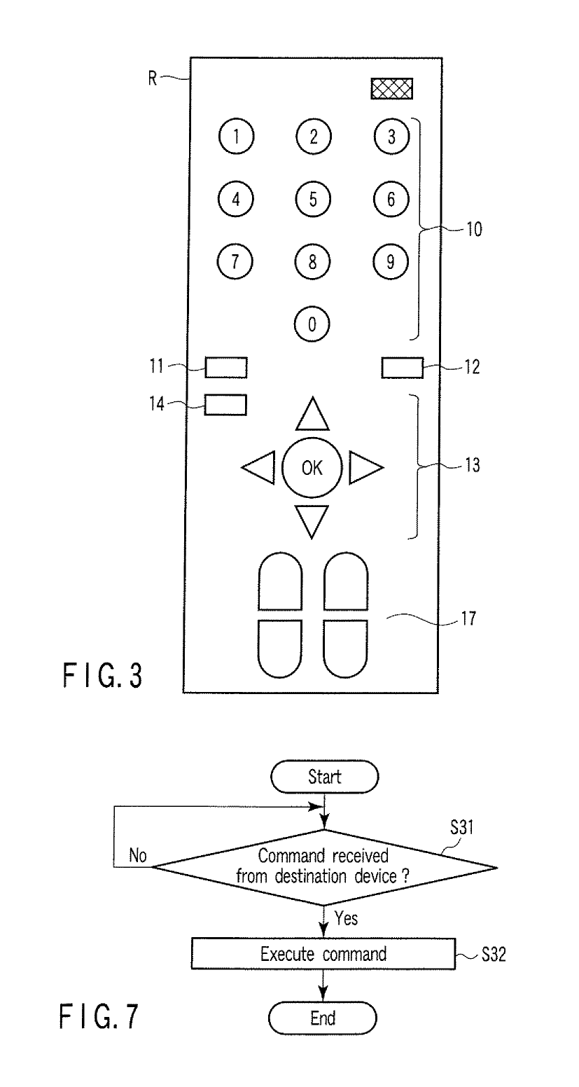

Next, an example of a video processing system that is one embodiment regarding the invention will be described in detail with reference to the drawings. FIG. 1 is a block configuration diagram depicting an example in a plurality of video processing systems regarding one embodiment of the invention. FIG. 2 is an explanation view depicting an example of HDMIs that are communication standards to be used in the plurality of video processing systems. FIG. 3 is an external appearance view depicting one example of the remote controllers to be used by video processing devices composing the plurality of video processing systems.

(One example of a Configuration of a Video Processing System That is an Embodiment Regarding the Invention)

The video processing system 1 that is an embodiment regarding the invention includes, in FIG. 1, a remote controller R, and a remote controller communication unit 133. Here, the remote controller R controls wirelessly a destination device 20 or a source device 30. While the remote controller R may utilize a wireless communication standard, such as IrDA and Bluetooth (registered trademark) for data communication in order to control remotely, the remote controller R is not limited to this utilization.

The destination device 20 is a device to display and output video audio data from the source device 30, and more specifically, the source device 30 is a television receiver, etc. The source device 30 is a device to supply the video audio data to the destination device 20, and more specifically, the source device 30 is an HDD-DVD player, etc.

The destination device 20 includes a control unit 130 that is a central processing unit, and the control unit 130 controls a storage unit 131, a communication unit 111, a display unit 141, and a remote controller communication unit 133. The storage unit 131 is a unit for storing various items of setting information such as a control program, and volume and video display settings of the destination device itself. More specifically, the storage unit 131 is a flash memory, a hard disc drive, etc.

The communication unit 111 is a unit which receives the video and audio data from the source device 30, transmits a command to control the source device 30, and receives the command from the side of the source device 30. In the concrete, the communication unit 111 is HDMI, a wired local area network (LAN), a wireless LAN, Bluetooth (registered trademark), etc. In the case of the HDMI, the CEC line is used for transmitting and receiving a control command.

The display unit 141 displays the menu screen for device-control and the video from the source device 30 and performs audio reproduction. More specifically, the display unit 141 is a liquid crystal panel, a loud-speaker, etc. The remote controller communication unit 133 receives the control command from the remote controller R. Concretely, the communication unit 113 is an IrDA light receiving module, a Bluetooth module, etc.

Meanwhile, the source device 30 includes a control unit 230 that is a central processing unit; the control unit 230 controls a storage unit 233, a communication unit 211, and a remote controller communication unit 231. The storage unit 233 stores various items of setting information such as a control program and volume and video display settings of the source device itself. And more specifically, the storage unit 233 is a flash memory, a hard disk drive (HDD), an HDD-DVD drive, etc.

The communication unit 211 transmits the video and audio data to the destination device 20, transmits a command (control signal) for controlling the destination device 20, and receives a command (control signal) from the side of the destination device 20. The menu screen for controlling the source device 30 is also transmitted to the destination device 20 as a video signal which has passed through the communication unit 211. The communication unit 211 is a unit which is mounted through an interface standard which is connectable with the communication unit 111 on the side of the destination device 20. In the concrete, the communication unit 211 is an HDMI, a wired LAN (local area network), a wireless LAN, Bluetooth (trademark), or the like.

The remote controller communication unit 231 is a unit which receives a control command supplied from the remote controller R′. In the concrete, the communication unit 211 is an IrDA light receiving module, a Bluetooth module, or the like.

In the embodiment, although the destination device 20 is an HDMI-equipped television receiver capable of being remotely controlled by an infra-red remote controller, a case, in which the remote controller R is a Bluetooth remote controller, or a case in which the communication unit 211 is a wireless interface such as a wireless HDMI and a wireless HDD, is a possible approach. Similarly, although the source device 30 is an HDMI-equipped HDD-DVD player capable of being remotely controlled by the infra-red remote controller, a case, in which the source device is a recording/reproducing device such as an HDD-DVD player, is a possible approach. While this embodiment will be described by using a representative combination, the control system of the remote controller and the standards of the communication units 111, 211 are not limited.

HDMI Terminal

In the case that the communication units 111, 211 are the HDMIs, each HDMI terminal 111 (121) has a connector pin arrangement, as shown in FIG. 2. Especially, in accordance with a CEC signal at a 13-th pin, transmitting/receiving the command defined in conformity with an HDMI-CEC protocol enables controlling an opponent party device.

While the remote controller R includes, as shown in FIG. 3, as an example, a set of figure key 10, an input key 11, a menu key 12, up-and-down and right-and left keys—a decision key (OK key) 13, a return key (cancellation key) 14, a volume key 17, etc., the invention is not limited this embodiment.

(One Example of Control Operation of Video Processing System That is One Embodiment Regarding the Invention)

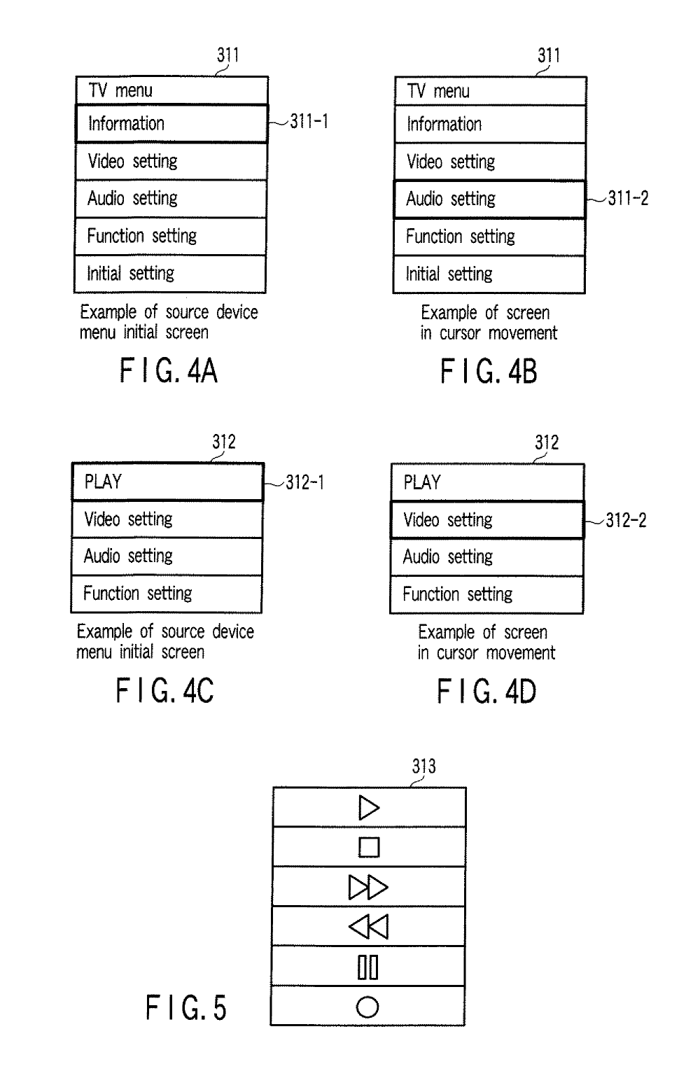

Next to this, concrete operations of the video processing devices (destination device, source device) 20, 30 having the aforementioned configurations will be described in detail by referring to a flowchart. FIGS. 4A-4D show examples of the menu screens which are displayed by the destination device 20 regarding the embodiment of the invention. FIG. 5 similarly shows an example of a PLAY screen in the menu screens to be displayed by the destination device 20.

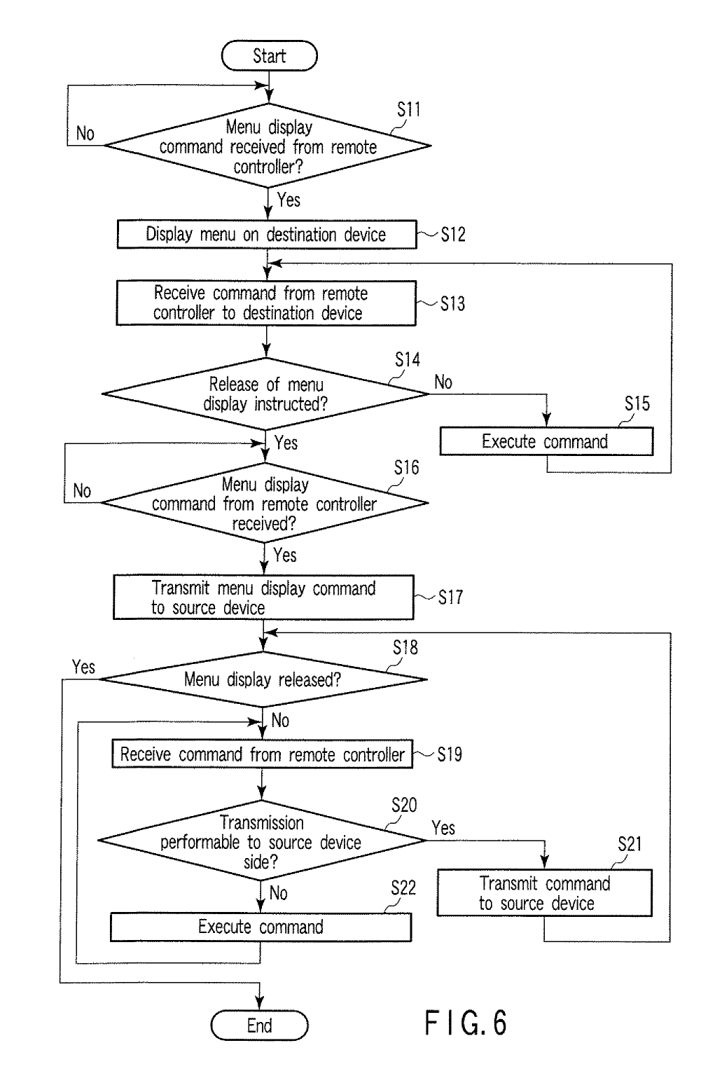

FIG. 6 shows a flowchart depicting an example of display processing of the menu screen to be similarly performed by the video processing device on the side of the destination device 20. FIG. 7 shows a flowchart depicting an example of a display processing of the menu screen to be performed by the video processing device on the side of the source device 30.

Each step in the flowcharts of FIGS. 6, 7 may be replaced with circuit blocks, thereby; all the steps of each flowchart may be re-defined as blocks.

### First Embodiment

### The Case of the Use of Remote Controller on the Side of Destination Device 20

As regards the first embodiment, a case in which the remote controller R on the side of the destination device 20 controls both the destination device 20 and the source device 30 will be described with reference to a flowchart.

Firstly, in an initial state, an HDMI cable 301 connects the television device (television receiver) that is the destination device 20 and the HDD-DVD player that is the source device 30, as shown in FIG. 1. It is assumed that a video input on the side of the destination device 20 is set to the HDMI terminal with the HDD-DVD player connected thereto. If the input setting on the side of the destination device 20 is set to any device other than the devices to be controlled in this embodiment (for example, a tuner or an HDMI input other than the tuner), it is preferable that the operations to be mentioned below are not performed.

The remote controller R is a remote controller for controlling the destination device 20, and the destination device 20 receives the command data to be transmitted by pressing the remote controller. It is preferable for the remote controller R to include, as shown in FIG. 3, at least four kinds of keys that are the menu key 12, the cursor movement key—decision key (OK key) 13, the return key (cancellation key) 14; however, the invention is not limited to the embodiment. While the cursor movement key moves in the directions of up-and-down and right-and-left in the example of FIG. 2, the cursor may move only in the direction of up-and-down, only in the direction of right-and-left, or may move multiple directions more than the movement in the directions of up-and-down and of right-and-left.

Referring to flowcharts of FIGS. 6, 7, the embodiment will be described below.

Firstly, operations on the side of the destination device 20 will be described with reference to the flowchart of FIG. 6. At first, when the user presses the menu key 12 of the remote controller R, the remote controller communication unit 133 receives a command for displaying the control menu of the destination device 20 (Step S11). When receiving the operation signal corresponding to the command, the control unit 130 of the destination device 20 turns into a destination control mode (a first control mode), and generates the menu screen of the destination device 20, overlaps the screen on the video signal, and displays the overlapped video signal onto the menu screen (Step S12).

FIG. 4A shows a menu initial screen 311 of the destination device 20. After this initial screen 311, an operation caused by the cursor 13 changes an ‘information’ 311-1 makes an active display shift to ‘audio setting’ 311-2 on the screen 311 shown in FIG. 4B. That is, the ‘information’ 311-1 framed by a heavy line shows a current position of the cursor, and of course, the cursor position may be shown by a way other than framed with the heavy line, for example, by a highlight display, by changing a color of a character, etc.

The destination control mode (a first control mode) is a mode to receive the command from the remote controller R (Step S13), when the user presses any key on the remote controller R, and the remote controller communication unit 133 receives the command data, the control unit 130 determines whether or not the command is one to instruct a ‘release instruction of a display of a menu screen’ (step S14).

That is, for instance, it is preferable to assume that the case in which the user has pressed the return key 14 or the user has pressed the menu key 12 again as the ‘release instruction of a display of a menu screen’. Other than this, it is preferable to generate the ‘release instruction of the display of the menu screen’ by ‘execution completion of a certain command’ or by transition of an inner state of the destination device 20.

In Step S14, if the release instruction of the display of the menu screen has made, the destination device 20 proceeds to Step 316 after releasing the display of the menu screen. If the release instruction of the display of the menu screen has not been made especially, the command received in Step S13 is executed (Step S15).

For instance, if the user presses the cursor down-movement key 13, the destination device 20 updates the menu screen to moves the cursor position by one item. If the user presses the decision key 13, the destination device 20 executes the item positioned by the cursor at that time point, and displays a sub menu if the sub menu exists.

When the cursor position is moved by tow items as shown in FIG. 4B, the destination device 20 receives the command from the remote controller R without a break. The steps so far are in the destination control mode (the first control mode), namely, in a self device control menu mode.

After completing a ‘self device control menu mode’ when receiving again a display command of a menu screen on the basis of the pressing of the menu key 12, etc., from the remote controller R (step S16), from this time point, the control object of the remote controller R changes to the source device 30 that is the HDD-DVD player connected to the destination device 20 through the HDMI. This state is a source control mode (a second control mode), namely, an ‘other device control menu mode’.

When receiving a display command of the menu screen in Step S16, the control unit 130 transmits a command to instruct ‘a display of a menu screen’ to the HDD-DVD player that is the source device 30 by way of the CEC line through the HDMI because the destination device 20 assumes the received display command as a display command of a menu screen for the HDD-DVD player.

The command instructing this ‘display of menu screen’ equivalents to <Menu Request> (“Active”) in a command system called “Device menu Control” in the CEC standard. The side of the HDD-DVD player that is the source device 30 receives this command, then, the control unit, etc., create and output the control menu.

The control menu is transmitted to the destination device 20 via the communication units 111, 211 as the video signal, and displayed on the screen of the display unit 141 of the destination device 20. FIG. 4C shows an example of an initial screen of the control menu of the HDD-DVD player that is the source device 30 to be displayed on the side of the destination device 20.

Like the menu which has been displayed by the destination device 20 in Step S12, the current position of the cursor is indicated with the heavy line. However, according to the operation state on the side of the source device 30, the menu screen may not be displayed at that time point.

The control unit 130 confirms whether or not the side of the destination device 20 has been released from the display status of the menu screen of the source device 30 (Step S18). After receiving the command in Step S17, and after receiving the command transmitted from the destination device 20 in Step S11, since the HDD-DVD player that is the source device 30 may release the display status of the menu screen, the destination device 20 transmits the command to the source device 30 in order to confirm the display status of the menu screen for the HDD-DVD player. The destination device 20 then determines whether or not the display status has been released depending on the response. If it is determined that the destination device 20 has been released, the control unit 130 terminates an ‘other device control menu’, and ends the processing of the embodiment. If it is determined that the destination device 20 has not been released, the remote controller unit 133 and the control unit 130 performs command reception from the remote controller R (step S19).

In the HDMI-CEC standard, <Menu Request> (“Query”) is equivalent to the release. The source device 30 which has received the CEC command reports the display status of the menu screen by <Menu Status> (“Activated”) and the release of the display status of the menu screen by <Menu Status> (“Deactivated”) to the destination device 20.

In Step S19, the control unit 130 and the remote controller communication unit 133 have been receiving the succeeding control commands from the remote controller R. There is a possibility for these control commands to intermix a command for controlling the source device 30 and a command forward the destination device 20. Of course, the command made by the cursor movement key and the decision key, etc., have to directed to the source command 30; however, it is foreseen that the control command (command for up/down of sound volume) directed only toward the destination device 20 is included.

The control unit 130 determines whether or not the command which has received in first may be transmitted to the source device 30 (Step S20). If it is determined that there is a command corresponding to the command which has received in first in a control command group of the source device 30 defined by the HDMI-CEC, the control unit 130 supplies the given command to the source device 30 (step S21).

Here, it is assumed that the remote controller R for the destination device 20 has keys for ‘PLAY’, ‘Pause’, and ‘STOP’. It is assumed that the commands transmitted to the destination device 20 by using these keys correspond to the commands existing in a “Deck Control” command system, and a “Remote Control Pass Through” command system, respectively. Such a command group may be transmitted to the source device 30.

For instance, in the display status of FIG. 4C, if the ‘cursor downward movement key’ 13 of the remote controller R has been pressed, the HDD-DVD player moves down the cursor position on the menu by one item, and shifts to the display status shown in FIG. 4D.

If the decision key (OK key) 13 or the return key 14 is pressed, the processing corresponding to the respective commands is executed. After transmitting the command, the control unit 130 proceeds to Step S18.

However, in Step S20, if it is determined that the command which has received in first may not transmit toward the source device 30, the control unit 130 proceeds to Step S19 after executing this command on the side of the destination device 20 (Step S22).

In a source device menu initial screen 312 of FIG. 4C, if a PLAY 312-1, or the like, is selected by the decision key 13, the operation screen shown in FIG. 5 is displayed. In response to the operations of the cursor key and the decision key 13 after this, reproduction, fast-forward, etc., of the source device 30 may be performed.

Operations on the side of the source device 30 will be described while referring to the flowchart of FIG. 7. The operations of the source device 30 are executed in the case in which the side of the destination device 20 is in the ‘other device control menu mode’. More specifically, the source device 30 executes the command received via the HDMI-CEC line, and reports the status in response to a query.

The DVD player that is the source device 30 operates in a relative simple manner. When the control unit 230 recognizes the processing corresponding to the CEC command which has been received by the communication unit 211 (Step S31), the control unit 230 executes the command (Step S32). The control unit 230 then repeats to return responses.

The side of the DVD player that is the source device 30 may only process the received CEC command without reference to the state of the side of the destination device 20.

With processing depicted in the foregoing two flowcharts, the user may arbitrarily call out the control of the destination device 20 and the source device 30 of the embodiment by using the single remote controller R for the destination device 20 and may make those devices 20, 30 perform desired operations.

In the aforementioned first embodiment, the first pressing of the remote controller R operates the destination device 20.

While the first embodiment firstly has brought the video processing system 1 into the destination control mode, namely self a device control menu mode (a first control mode), and the second pressing of the remote controller R has brought the system 1 into a ‘source control mode’ for operating the source device 30, namely an ‘other device control menu mode’ (a second control mode), the invention is not limited to this order, and it is preferable for the invention to operates in the reverse order or other orders.

While the pressing of the menu key 12 of the remote controller triggers the operation of the system 1, the invention is not limited to this menu key 12, the pressing of another key produces a preferred embodiment.

### Second Embodiment

### Case of Use of Remote Controller on Side of Source Device 30

In the second embodiment, the video processing system 1 uses a remote controller R′ on the side of the source device 30 to perform a control operation in the destination control mode and a source control mode shown in the first embodiment.

It may be thought that the operations of the second embodiment are the same as those of the case in which the destination device 20 and the source device 30 in FIGS. 6, 7 are thoroughly replaced, and the second embodiment operates in accordance with the same principle as that of the first embodiment.

That is, the first embodiment has described about the processing to alternatively switch the ‘self device control menu mode’ and the ‘other device control menu mode’ by using the menu keys of the remote controller for the television receiver. It is possible for the same processing to be implemented by using the remote controller for the source device, namely the remote controller of the HDD-DVD player. The same processing may be implemented because the CEC line has a mechanism enabling an interactive exchange of commands. Although the detail of the flowchart and processing in this embodiment will be eliminated, on the side of the source device also may alternatively switch the ‘self device control menu mode’ and the ‘other device control menu mode’ by using the menu key menu key 12 as a trigger.

More specifically, the source device 30 switches between a mode in which the source device 30 creates the menu screen in response to pressing of the menu key of the remote controller to output the video signal on the menu screen and a mode in which the command (control signal) to display the menu screen is output to the destination device 20 in response to the pressing of the menu key.

According to the processing given above, the user may call out the control menus of the two devices by using the single remote controller for the DVD player and may operate the player at user's request.

### Third Embodiment

### Termination and Interruption Processing in ‘Other Control Menu Model’

The third embodiment concretely specifies termination processing and interruption processing of the ‘other device control menu mode’.

Termination Processing

That is, the first embodiment has determined the termination of the ‘other device control menu mode’ by transmitting the CEC command for confirming the display status of the menu screen on the side of the HDD-DVD player from the television receiver. However, this processing means that, as the result of the execution of the CEC command, the HDD-DVD player becomes a main unit and the side of the television receiver waits for the release of the display status of the menu screen caused by the HDD-DVD player. However, a case, in which the user actively desires to release the display status of the menu screen of the HDD-DVD player, is possible approach.

In such a case, if the video processing system may send a command meaning ‘display release of menu screen’ to the HDD-DVD player when the user presses any one of buttons of the remote controller R as a trigger, the convenience for the user is improved.

Accordingly, as one example, in a state that the television receiver is in the ‘other device control menu mode’, if the menu key 12 of the remote controller R is pressed again, it is preferable for the control unit 130 of the destination device 20 to interpret that this pressing operation means ‘the release of the display status of the menu screen of the HDD-DVD player by the user’ and end the ‘other device control menu mode’.

Thereby, the control unit 130 (television receiver) of the destination device 20 transmits a ‘release command of a display status of a menu screen’ to the DVD player through the CEC line. In the CEC standard, the <Menu Request> (“Deactivate”) in the command system called “Device Menu Control” is equivalent to the forgoing transmission of the release command. Transmitting the command to the source device 30 in response to the re-pressing of the menu key 12 makes the user able to terminate the ‘other device control menu mode’ at the desired timing.

Interruption Processing

While the first embodiment has described on the assumption that the case in which the ‘other device control menu mode’ sets the video and audio signal input of the television receiver to the input from the control target source device, it is also assumed that the user switches the input of the television receiver in the ‘other control menu mode’. For instance, the user temporarily switches to a tuner for a terrestrial digital broadcasting in the middle of viewing of the video on the DVD player is a possible approach. In this case, it is not preferable for the remote controller R to be still in the ‘other device control menu mode’ from the view point of operations. Thus, it is preferable to automatically interrupt the ‘other device control menu mode’.

Therefore, in the state in which the television receiver is set in the ‘other device control menu mode’, if an input source is switched from the source device (HDD-DVD player, etc.) to another device, it is preferable to interrupt once the ‘other device control menu mode’.

After this, when confirming that the user has retuned again the input source to the source device (HDD-DVD player, etc.), it is preferable for the control unit 130 of the destination device 20 to restart the interrupted ‘other device control menu mode’.

During interruption, the television receiver brings into a normal operation mode, commands transmitted from the remote controller R do not determine ‘whether transmission to the source device 30 is enabled’, and do not transmit any CEC command. Thereby, the user may freely switch the input for the television receiver at any time. Further, at a time point when the user has pressed the input switch button, if the DVD player is in a reproduction state, it is preferable to transmit a ‘Pause’ CEC command to the HDD-DVD player then interrupt the ‘other device control menu mode’.

That is, in a time period in which the user switches the input to watch another video, the DVD player temporarily stops the reproduction, and further, at a time point when the user has recovered the input to the original one, if the control unit 130 transmits the ‘PLAY’ CEC command, the user may watch the continuation of the video scene before switching the input.

Thereby, the user does not miss even a part of the scene to be reproduced by the HDD-DVD player, and furthermore, the user may prevent malfunction of the control of the remote controller R.

As mentioned above, according to the embodiments of the invention, alternatively switching the control mode of the destination device and the control mode of the source device between the destination device and the source device connected through the interface which is mutually communicable the control commands enables the two devices to be controlled by the single remote controller.

Where the source device is in the reproduction mode and the destination device switches inputs, a temporary stop command is supplied to the source device, and then the control of the source device is temporarily stopped. A reproduction command is supplied when the input has restored to the original state. In this manner, the user does not miss the scene reproduced by the source device during the input switching.

(Concrete Example of Video Processing System That is an Example Regarding the Invention)

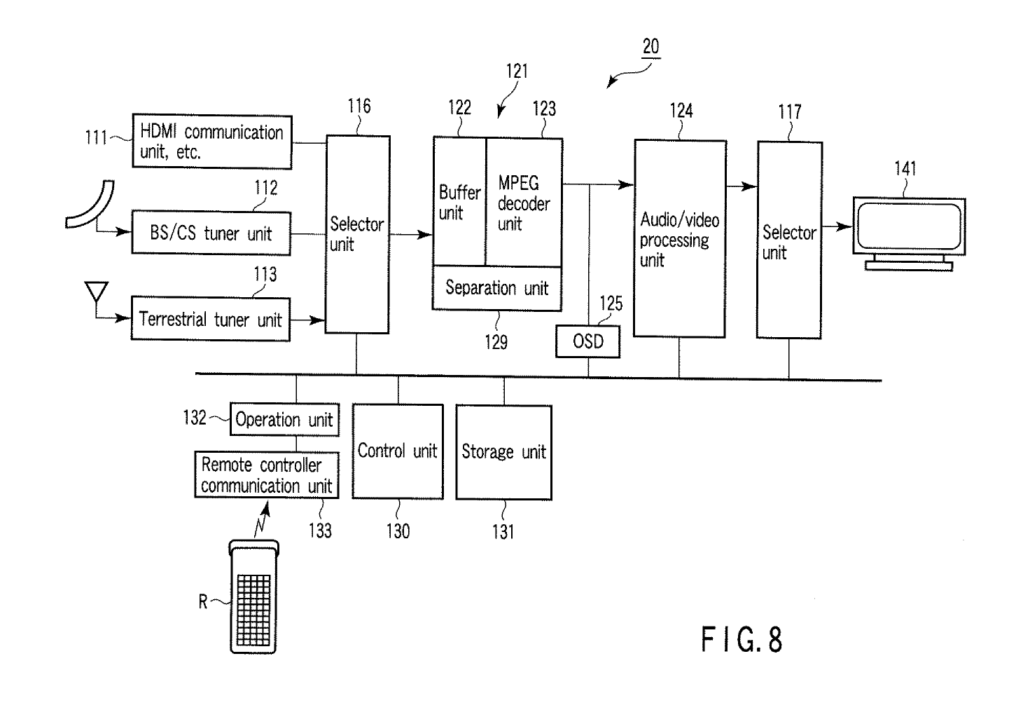

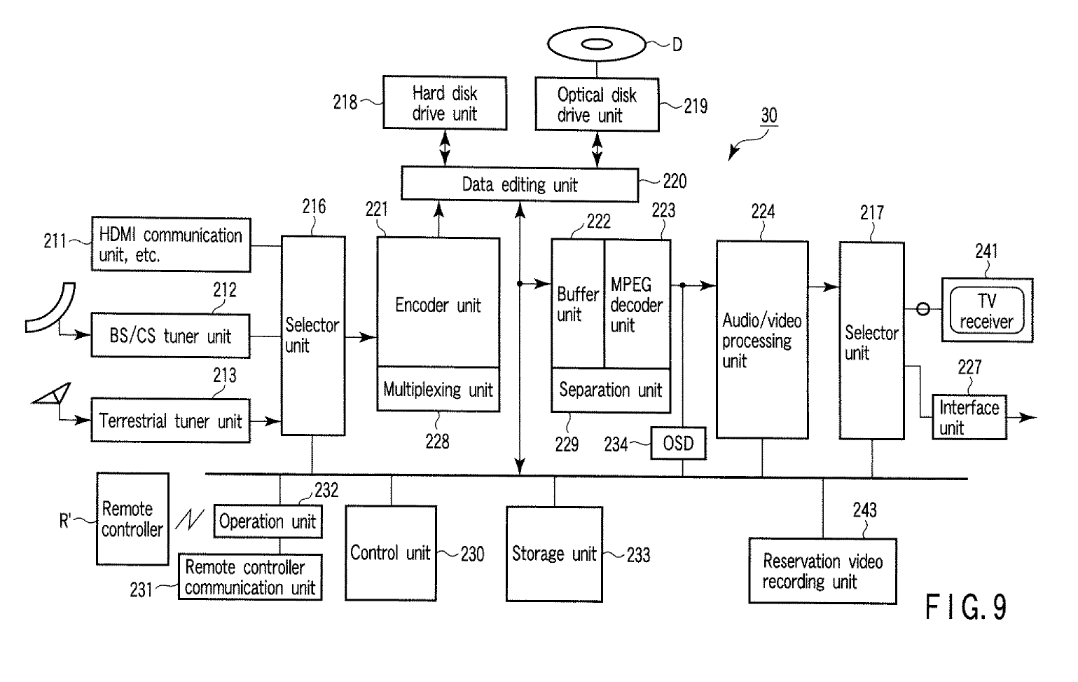

Referring now to the drawings, a concrete example of the foregoing video processing example will be described below. FIG. 8 shows a block configuration diagram illustrating an example of a configuration of a video processing device on a destination side regarding the invention. FIG. 9 is a block configuration diagram illustrating an example of a configuration of a video processing device on a source side.

Destination Device 20

The destination device 20 is, as shown in FIG. 8, a digital television receiver as an example. The destination device 20 includes a selector unit 116 on an input side, and a selector unit 117 on an output side. The foregoing communication unit 111 such as a LAN, an HDMI and a display port, the BS/CS tuner unit 112 that is a satellite broadcasting and a terrestrial tuner unit 113 are connected to the selector unit 116 on the input side and outputs a signal to the encoder unit 121. A satellite antenna and a terrestrial antenna are connected to the BS/CS tuner unit 112 and the terrestrial tuner unit 113, respectively.

The destination device 20 includes a buffer unit 122, an MPEG decoder unit 123, an audio video processing unit 124, an OSD 125 for overlapping an operation signal, etc., on a video signal, and a separation unit 129, and these each unit is connected to the control unit 130 for controlling the entire operation of the video processing device via a data bus. Further, the output from the selector unit 117 is connected to the display unit 141.

Moreover, the destination unit 20 includes the remote controller communication unit 133 for receiving the operation by the user and the operation of the remote controller R. Here, the remote controller R enables almost the same operation as that of an operation unit 132 to be disposed at the main unit of the destination device 20, and may perform various settings such as an operation of the tuner and a setting of a reservation for video recording.

As mentioned above, the destination device 20 having such a configuration also selectively enables control of both the destination device 20 and the device connected to the remote controller R through the HDMI-CEC, etc., by switching through pressing a menu key, etc., on a single remote controller.

Source Device 30

The source device 30 is, as shown in FIG. 9, as an example, a hard disk recorder for handling an HDD-DVD. The source device 30, as shown in FIG. 9, includes two kinds of disk drive units. The source device 30 firstly includes an optical disk drive unit 219 which rotates and drives an optical disk D as a first medium that is an information recording medium capable of constructing a video file and executes reading information. Here, although the optical disk D is an HDD-DVD as an example, the optical disk D is not limited to the HUD-DVD. The source device 30 has a hard disk drive unit 218 which drives a hard disk as a second medium. The control unit 230 is connected to each unit via a data bus so as to control an entire operation of the video processing device.

The source device 30 shown in FIG. 9 mainly includes an encoder unit 221 composing a recording side, an MPEG decoder unit 223 composing a reproduction side, and a control unit 230 controlling operations of the main unit of the device. The source device 30 has a selector unit 216 on an input side and a selector unit 217 on an output side, and a communication unit 211 such as a LAN, a satellite broadcasting (BS/CS) tuner unit 212 and a terrestrial tuner unit 213 are connected to the selector unit 216 on the input side to output a signal to the encoder unit 221. A satellite antenna and a terrestrial antenna are connected to the tuner unit 212 and the tuner unit 213, respectively.

The source device 30 includes an encoder unit 221, a data editing unit 220 receiving the output from the encoder unit 221 to perform desired data processing such as data editing, a hard disk drive unit 218 to be connected to the data editing unit 220, and an optical disk drive unit 219. The source device 30 further includes a hard disk drive unit 218, an MPEG decoder unit 223 which receives a signal from an optical disk drive unit 219 to decode the signal, the encoder unit 221, a buffer unit 222, the MPEG decoder unit 223, a multiplexing unit 228, a separation unit 229, the control unit 230, an OSD unit 243 synthesizing a video screen with desired video, a secondary management unit 242 and a reservation video recording unit 243 generating a reservation list and a program list image. Each unit is connected to the control unit 230 via the data bus. Further, an output from a selector unit 217 is connected to an external receiver 241 or supplied to an external device via an interface unit 227 communicating with the external device.

Moreover, the source device 30 is connected to the control unit 230 via the data bus, and has an operation unit 232 receiving the operation by the user and the operation from the remote controller R. Here, the remote controller R may almost the same operation as that of the operation unit 232 disposed by the main unit of the source device 30, and may perform various settings such as recording and reproducing instruction of the hard disk drive unit 218 and the optical disk drive unit 219, editing instruction, operations of the tuner units and setting of reservation video recording.

In the source device 30 having such a configuration, an outline of reproduction processing and recording processing of the optical disk D will be described as an example. That is, under the control by the control unit 230, the optical disk D to be rotated at a predetermined speed reflects laser light, an optical pickup detects the reflected light, and a detection signal based on the reflected light is output. An RE signal is generated on the basis of the detection signal, and reproduction processing, which is continued from reading processing of data, is performed.

In recording processing of the optical disk D under the control by the control unit 230, for example, the data which has been supplied through the selector 216 via an input unit (not shown) is supplied to the encoder unit 221 and encoded to be output. In response to the encoded output and the output from the control unit 230, a driving current for a laser driver is supplied to the optical pickup, the laser light is illuminated on a storage area of the optical disk D then the recording processing is performed.

As mentioned above, the destination device 20 and the source device 30 that are the embodiment regarding the invention are actuated by the foregoing television receiver, the hard disk recorder, etc. With switching by pressing a menu key, etc., of a single remote controller, both controls for a device to be controlled by the pressing of the menu key, etc., and for a device to be connected to the device to be controlled by the menu key through the HDMI-CEC, etc., may be selectively performed. However, the invention is not limited to the embodiments and is applicable to many kinds of video processing devices.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video processing device comprising:
a communication unit configured to communicate with other video processing devices via communication paths;
a remote controller communication unit configured to receive operation signals corresponding to key operations of a remote controller;
a display unit configured to display video; and
a control unit configured to perform processing by selecting either a first control mode which creates a menu screen in response to reception of operation signals corresponding to presses of a menu key of the remote controller to display the menu screen on the display unit or a second control mode which transmits a control signal to output the menu screen to other video processing devices in response to the reception of the operation signals corresponding to the presses of the menu key and also displays a video signal to be received from other video processing devices on the display unit.

2. The device according to claim 1, wherein
the control unit is configured to select either the first control mode or the second control mode in response to the number of reception times of the operation signals corresponding to the presses of the menu key received by the remote controller communication unit.

3. The device according to claim 1, wherein
the communication unit is configured to be compatible with a communication standard performing interactive communication to transmit the control signal and performing one-way communication to transmit the video signal through an identical cable.

4. The device according to claim 1, wherein
the communication unit is configured to communicate according to a high-definition multimedia interface standard.

5. A video processing device comprising:
a communication unit configured to communicate with other video processing devices via communication paths; and
a control unit configured to perform processing by selecting either a first control mode which creates a menu screen in response to reception of operation signals corresponding to presses of a menu key of the remote controller to output a video signal of a menu screen from the remote controller communication unit or a second control mode which transmits a control signal so as to display the menu screens to be created by other video processing devices to the other video devices in response to reception of the operation signals corresponding to the presses of the menu key.

6. The device according to claim 5, wherein
the control unit is configured to select either the first control mode or the second control mode in response to the number of reception times of the operation signals corresponding to the presses of the menu key received by the remote controller communication unit.

7. The device according to claim 5, wherein
the communication unit is configured to be compatible with a communication standard performing interactive communication to transmit the control signal and performing one-way communication to transmit the video signal through an identical cable.

8. The device according to claim 5, wherein
the communication unit is configured to communicate according to a high-definition multimedia interface standard.

9. A video processing method comprising:
receiving operation signals corresponding to presses of a menu key of a remote controller; and
performing processing by selecting either a first control mode which creates a menu screen in response to reception of operation signals corresponding to presses of the menu key of the remote controller to output a video signal of a menu screen from the remote controller communication unit or a second control mode which transmits a control signal so as to display the menu screen to be created by other video processing devices to other video devices in response to reception of the operation signals corresponding to the presses of the menu key.

10. The method according to claim 97 wherein
the performing of the processing by selecting either the first control mode or the second control mode selects either the first control mode or the second control mode in response to the number of reception times of the operation signals corresponding to the presses of the menu key.
